(19) United States
(12) Patent Application Publication
(10) Pub. No.: US 2003/0103151 A1
(43) Pub. Date: Jun. 5, 2003

(54) Image sensor having photosensitive color filters

(76) Inventor: Xiaodong Luo, Sunnyvale, CA (US)

Correspondence Address: PERKINS COIE LLP, PATENT-SEA, P.O. BOX 1247, SEATTLE, WA, 98111-1247, US

(21) Appl. No.: 10/007,114

(22) Filed: Dec. 3, 2001

(51) Int. Cl. H04N 5/335

(52) U.S. Cl. 348/273

(57) ABSTRACT

An image sensor is disclosed. The image sensor comprises a plurality of pixels formed into a two-dimensional sensing array. Further, the pixels are covered with color filters that have an opacity that varies in accordance with the intensity of incident light.

### TECHNICAL FIELD OF THE INVENTION

The present invention relates generally to image sensors, and more particularly, relates to an image sensor that includes color filters that vary in opacity depending upon the intensity of incident light.

### BACKGROUND OF THE INVENTION

Integrated circuit technology has revolutionized various fields including computers, control systems, telecommunications, and imaging. For example, in the imaging field, CMOS image sensors have proved to be less expensive to manufacture relative to CCD imaging devices. Further, for certain applications, CMOS devices are superior in performance. In addition, the signal processing logic necessary can be integrated alongside the imaging circuitry, thus allowing for a single integrated chip to form a complete stand alone imaging device. However, for some other applications, CCD imaging devices still have some advantages.

The primary building block of an image formed by an image sensor is a pixel. The number, size, and spacing of the pixels determine the resolution of the image generated by the imaging device. The pixels of an image sensor are semiconductor devices that transform incident light photons into current signals. The signal produced by each pixel is generally extremely small.

One important parameter that the image sensor must be able to control is the exposure time of each pixel to incident light. Similar to light exposure time for photographic film, the exposure time of each pixel must be adjusted to compensate for variations in lighting conditions, such as for indoor or outdoor lighting. An exposure time that is too long will result in an image that is overly bright and washed out. In contrast, an exposure time that is too short will result in an image that is dark and difficult to view.

Another method of varying the intensity of the pixel signals is to adjust the gain of the amplification circuitry. In many ways, controlling the gain is substantially similar to controlling the exposure time. By varying one or both, the image generated by the image sensor can be optimized for viewing.

Nevertheless, the length of exposure time and the amount of gain is limited, and for certain image sensor applications, may not be sufficient to compensate for changes in ambient lighting.

To form a color image sensor, color filters are placed above individual pixels. The color filters are typically red, green, and blue, commonly formed in a Bayer pattern over the pixel array. An example of one color filter structure is shown in U.S. Pat. No. 6,297,071. However, in all prior art color filter structures, the material used to form the color filter structure has a constant opacity, regardless of ambient light intensity.

### BRIEF DESCRIPTION OF THE DRAWINGS

Non-limiting and non-exhaustive embodiments of the present invention will be described in the following figures, wherein like reference numerals refer to like parts throughout the various views unless otherwise specified.

FIG. 1 is a schematic diagram showing an image sensor formed in accordance with the present invention.

FIG. 2 is a flow diagram illustrating the method of the present invention.

### DETAILED DESCRIPTION OF THE ILLUSTRATED EMBODIMENTS

The present invention describes an image sensor that incorporates color filters that have variable opacity dependent upon the intensity of incident light. The opacity can be varied inherently by the material used to form the color filter, or alternatively, the opacity may be electrically controlled in response to the intensity of incident light. In the following description, numerous specific details are provided to provide a thorough understanding of embodiments of the invention. One skilled in the relevant art will recognize, however, that the invention can be practiced without one or more of the specific details, or with other methods, components, etc. In other instances, well-known structures or operations are not shown or described in detail to avoid obscuring aspects of various embodiments of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

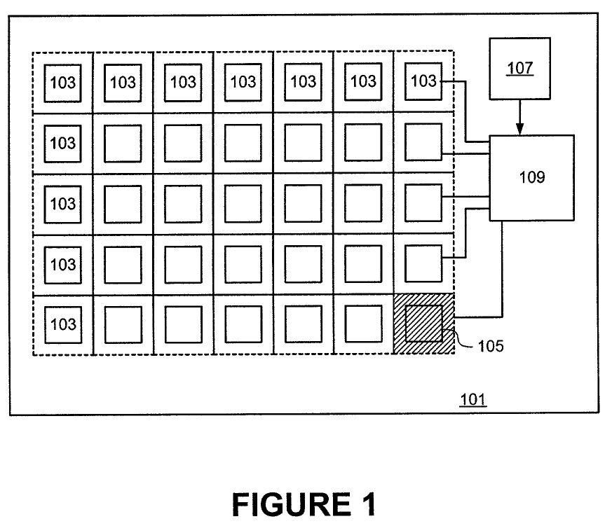

Turning to FIG. 1, an image sensor 101 formed in accordance with the present invention is shown. The image sensor 101 includes a two-dimensional array of pixels 103. The pixels are adapted to convert incident light into an electrical signal. The electrical signals from each pixel 103 are then read and used to form an image. In the interest of clarity, the readout circuitry and signal processing circuitry is omitted in FIG. 1.

Formed atop of each pixel 103 are color filters 105. The color filters 105 are disposed atop of each pixel in order to, in accordance with conventional color processing techniques, transmit only incident light that has a color corresponding to the particluar color filter 105. Typically, the color filters 105 have various colors, such as red, green, and blue. The specific colors of color filters 105 may then be arranged in the well-known “Bayer” pattern to provide a color image. Alternatively, the color filters 105 may be cyan, yellow, and magenta. The above describes a prior art color image sensor, such as that manufactured by OmniVision Technologies, Inc of Sunnyvale, Calif.

However, unlike previous color image sensors, in accordance with the present invention, the color filters 105 are formed from a material that is photosensitive (or photochromaic). In other words, the darkness of the pigmentation of the color filters 105 varies according to the intensity of incident light. As the intenisty of incident light decreases, the opacity (darkness) of the color filters 105 decreases. Thus, in low light levels, the color filters 105, in one embodiment, become almost clear. This allows for a greater dynamic range for the image sensor 101.

The materials capable of this type of photosensitivity are used in the flat panel display industry. These materials may easily be adapted for use as color filters for image sensors, because of their current use in semiconductor fabrication applications for the flat panel displays. For example, color filter materials may be available from Brewer Science, Inc. This material can be selectively deposited onto the pixels of the image sensor using conventional deposition and etching techniques. By using this material, the color filters 105 can automatically adjust to varying light levels.

Other materials require the application of an electrical signal in order to modify the opacity of the material. Thus, in one embodiment, a photodetector 107 is used to monitor the intensity of light incident onto the image sensor 101. The photodetector 107 sends a signal to a color filter controller 109. The color filter controller 109, taking the signal from the photodetector 107, can then provide an appropriate electrical signal to the color filters 105 in order to change their opacity.

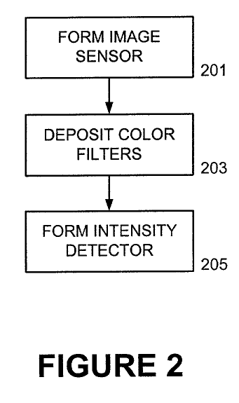

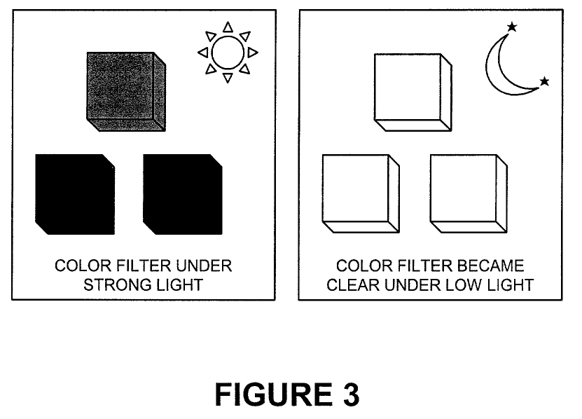

FIG. 2 illustrates a method of the present invention for forming an image sensor. First, at a box 201, the image sensor 101 is formed. Next, at box 203, the color filters 105 are then deposited onto the pixels 103 of the image sensor 101. As previously described, the color filters 105 are formed from a material that has variable opacity, either controlled by an electrical signal or automatically. Finally, in one embodiment, the photodetector 107 is formed onto the image sensor 101 at box 205.

While in one embodiment, the present invention is described in terms of color filters, the present invention may also be used with black and white (gray scale) image sensors as a method for automatic exposure control in order to increase dynamic range. Specifically, in a black and white image sensor, no filtering layer is deposited over the pixels. However, in accordance with the present invention, a filtering layer may be deposited uniformly over the pixel array, without regard to color. In such a situation, a photosensitive filtering layer is used to reduce the intensity of incident light by darkening, when the incident light is bright. During normal or low light conditions, the photosensitive filtering layer becomes nearly translucent. Thus, the term “color filter” as used herein also refers to a photosensitive filter layer that is monochrome.

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An image sensor comprising:
a plurality of pixels formed into a two-dimensional sensing array, each of said pixels adapted for converting incident light into an electrical signal; and
a plurality of color filters formed over said plurality of pixels, said color filters having an opacity that varies in accordance with the intensity of incident light.

2. The image sensor of claim 1, further including means for detecting the intensity of said incident light and means for applying an electrical signal to said color filters to vary the opacity.

3. The image sensor of claim 1 wherein said color filters are formed from a photosensitive material that increases in opacity as the intensity of said incident light increases.

4. The image sensor of claim 1, wherein said color filters are comprised of red, green, and blue filters.

5. A method, comprising:
forming a sensing array comprised of a two-dimensional array of pixels, said pixels adapted to convert incident light into an electrical signal;
depositing color filters over said array of pixels, said color filters formed from a material that has a variable opacity.

6. The method of claim 5, wherein said material has an opacity that is dependent upon the intensity of incident light.

7. The method of claim 5, wherein said material has opacity that can be controlled by an electrical signal.

8. The method of claim 5 further including forming means for detecting the intensity of the incident light.
